(19) United States
(12) Patent Application Publication
(10) Pub. No.: US 2019/0279280 A1
(43) Pub. Date: Sep. 12, 2019

(54) VIRTUAL REALITY TICKET PURCHASING PREVIEW

(71) Applicant: INTERNATIONAL BUSINESS MACHINES CORPORATION, ARMONK, NY (US)

(72) Inventor: Robert Roy Paar, Ridgewood, NY (US)

(21) Appl. No.: 15/917,869

(22) Filed: Mar. 12, 2018

(51) Int. Cl. G06Q 30/06; G06Q 10/02; G06T 11/60

(52) U.S. Cl. CPC G06Q 30/0641; H04L 67/38; G06T 11/60; G06Q 10/02

(57) ABSTRACT

A method for previewing a seat vantage-point in virtual reality for a venue. The method includes retrieving a seating chart for a venue from a database, receiving a user seat location selection within the seating chart for the venue, generating seat vantage-point data to be rendered in virtual reality based on the user seat location selection for the venue, and transmitting the generated seat vantage-point data to a user device, to be rendered in virtual reality. The method further includes receiving a seat availability, within the seating chart for the venue, for an event. The method further includes receiving an updated user seat location selection, within the seating chart for the venue, and adjusting the generated seat vantage-point data to be rendered in virtual reality based on the received updated user seat location selection.

### BACKGROUND

Embodiments of the present invention relate generally to the field of computing and more particularly to data processing and providing virtual reality as a service.

Purchasers of tickets to concerts, sporting events, and other stadium or venue-based activities have limited, two-dimensional purview into seating arrangements and, as such, cannot make the most informed ticket purchase decision from a merchant's website or mobile application.

Currently, there is no available service that would allow a ticket buyer to see the venue from the vantage-point of a seat location, in virtual reality, that they are about to buy.

### SUMMARY

Embodiments of the invention include a method, computer program product, and system, for previewing a seat vantage-point in virtual reality for a venue.

According to an embodiment, a method for previewing a seat vantage-point in virtual reality for a venue, wherein the method includes retrieving a seating chart for a venue from a database, receiving a user seat location selection within the seating chart for the venue, generating seat vantage-point data to be rendered in virtual reality based on the user seat location selection for the venue, and transmitting the generated seat vantage-point data to a user device, to be rendered in virtual reality.

A computer program product, according to an embodiment of the invention, includes a non-transitory tangible storage device having program code embodied therewith. The program code is executable by a processor of a computer to perform a method. The method includes retrieving a seating chart for a venue from a database, receiving a user seat location selection within the seating chart for the venue, generating seat vantage-point data to be rendered in virtual reality based on the user seat location selection for the venue, and transmitting the generated seat vantage-point data to a user device, to be rendered in virtual reality.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes retrieving a seating chart for a venue from a database, receiving a user seat location selection within the seating chart for the venue, generating seat vantage-point data to be rendered in virtual reality based on the user seat location selection for the venue, and transmitting the generated seat vantage-point data to a user device, to be rendered in virtual reality.

### BRIEF DESCRIPTION OF THE SEVERAL VIEWS OF THE DRAWINGS

FIG. 1 illustrates virtual reality generation computing environment 100, in accordance with an embodiment of the present invention.

FIG. 2 is a flowchart illustrating the operation of virtual reality module 130, in accordance with an embodiment of the present invention.

FIG. 3 depicts a seating chart for a venue on a user device, in accordance with an embodiment of the present invention.

FIG. 4 depicts an interactive preview of a user seat location selection within a seating chart for a venue on a user device, in accordance with an embodiment of the present invention.

FIG. 5 is a diagram graphically illustrating the hardware components of virtual reality generation computing environment 100 of FIG. 1, in accordance with an embodiment of the present invention.

FIG. 6 depicts a cloud computing environment, in accordance with an embodiment of the present invention.

FIG. 7 depicts abstraction model layers of the illustrative cloud computing environment of FIG. 6, in accordance with an embodiment of the present invention.

### DETAILED DESCRIPTION

Virtual reality (VR) as a service may allow for a 360-degree viewpoint from a seat location vantage-point within a stadium or venue seating chart, all from the convenience of one's mobile device, prior to purchasing a seat ticket.

VR as a service may be offered to many other types of customers aside from events management companies (i.e. event ticket purchases). Some examples may include restaurants, cruise lines, vacation packages, tourism companies, hotel chains, and airlines just to name a few.

The present invention allows for a ticket buyer to see a venue from the vantage point of the seat they are about to buy, prior to purchasing, in virtual reality. The present invention leverages existing VR technology to create a service that can be called, via an application programming interface (API), by a traditional third party e-commerce event ticket retailer. During the checkout process on these third-party e-commerce websites, a buyer could click a link to preview their seat selection and then continue on to purchase, if they so choose. If the buyer is unhappy with their previewed seat selection (e.g. obstructed views, poor angles, too far away, etc.), they would be able to preview a different available seat prior to purchase.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

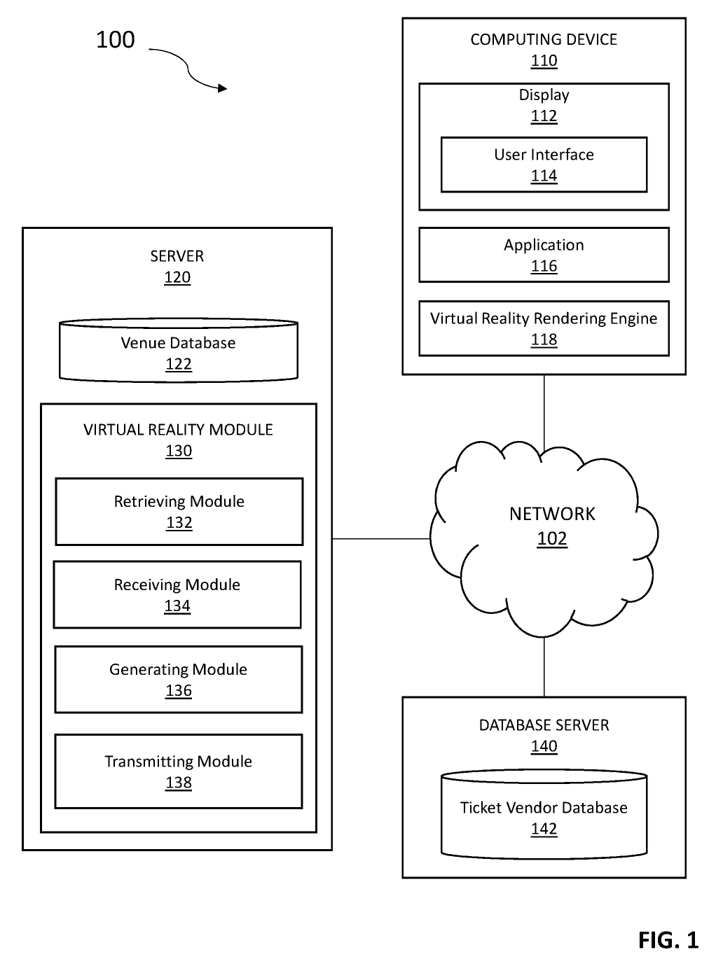

FIG. 1 illustrates virtual reality generation computing environment 100, in accordance with an embodiment of the present invention. Virtual reality generation computing environment 100 includes computing device 110, server 120, and database server 140 all connected via network 102. The setup in FIG. 1 represents an example embodiment configuration for the present invention, and is not limited to the depicted setup in order to derive benefit from the present invention.

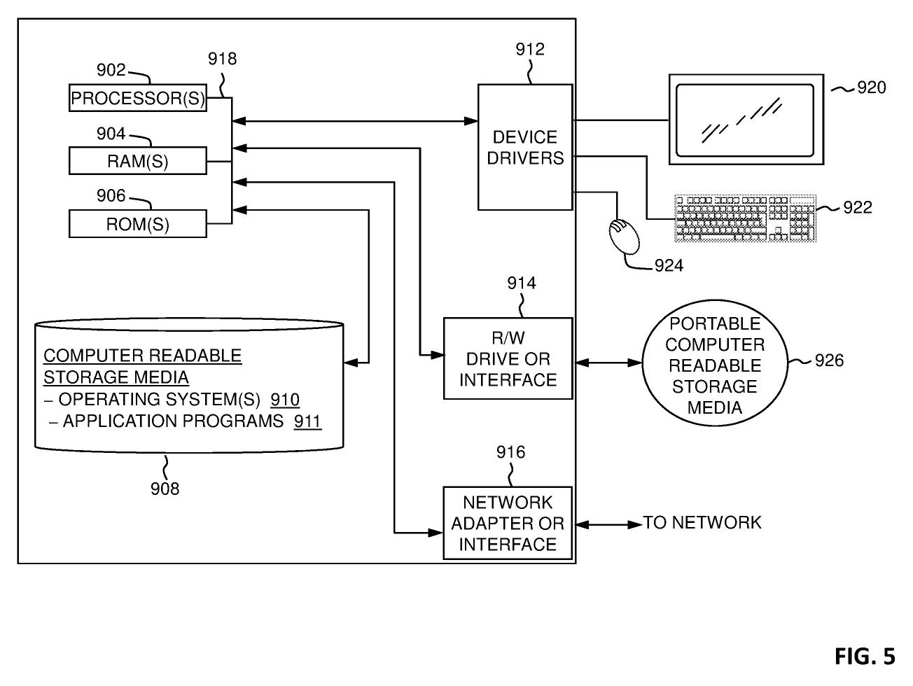

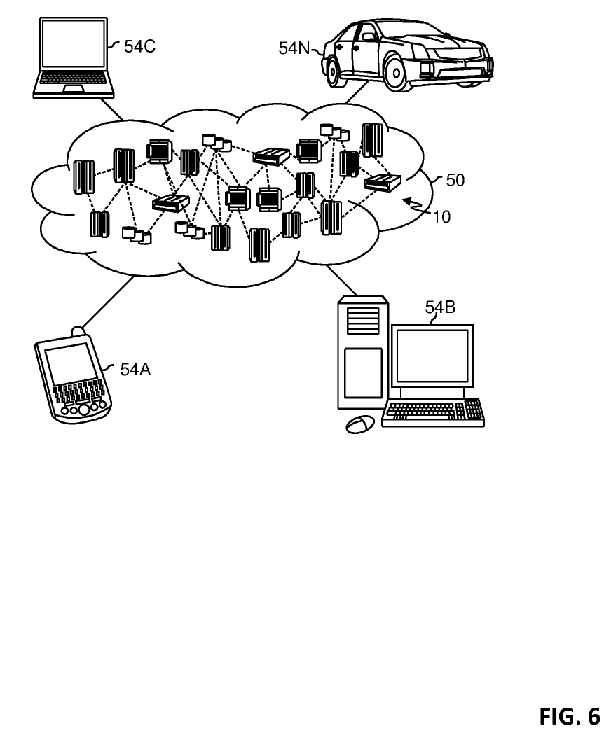

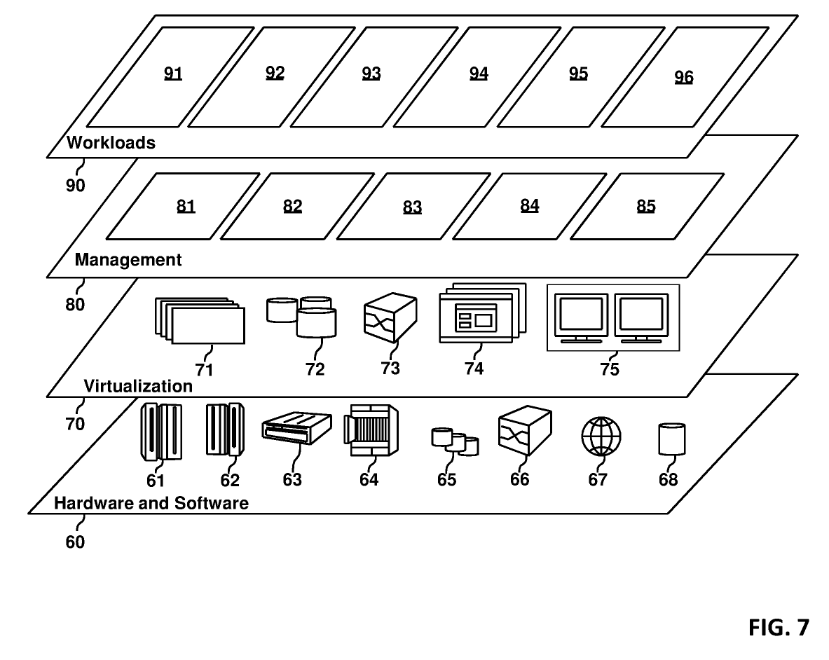

In an exemplary embodiment, computing device 110 contains display 112, user interface 114, application 116, and virtual reality (VR) rendering engine 118. In various embodiments, computing device 110 may be a laptop computer, tablet computer, netbook computer, personal computer (PC), a desktop computer, a personal digital assistant (PDA), a smart phone, or any programmable electronic device capable of communicating with server 120 and database server 140 via network 102. Computing device 110 may include internal and external hardware components, as depicted and described in further detail below with reference to FIG. 5. In other embodiments, computing device 110 may be implemented in a cloud computing environment, as described in relation to FIGS. 6 and 7, herein. Computing device 110 may also have wireless connectivity capabilities allowing it to communicate with server 120 and database server 140, as well as other computers or servers over network 102.

In an exemplary embodiment, display 112 receives data from VR rendering engine 118 and displays the VR rendered data from virtual reality module 130. Display 112 may be connectively coupled to hardware components, such as those depicted in FIG. 5, for displaying user input and/or received data.

In an exemplary embodiment, user interface 114 may be a computer program that allows a user to interact with computing device 110 and other connected devices via network 102. For example, user interface 114 may be a graphical user interface (GUI). In addition to comprising a computer program, user interface 114 may be connectively coupled to hardware components, such as those depicted in FIG. 5, for receiving user input. In an exemplary embodiment, user interface 114 may be a web browser, however in other embodiments user interface 114 may be a different program capable of receiving user interaction and communicating with other devices.

In an exemplary embodiment, application 116 may be a web browser or other computer program, on computing device 110, that is capable of accessing third party ticket website vendor platforms for the purpose of viewing, selecting, and purchasing assigned seating tickets for a show, movie, competition, performance, sporting event, or any other live or recorded performance at a particular venue. Application 116, in the exemplary embodiment, may be capable of accessing ticket vendor database 142 to view seat availability for a particular event at a particular venue. In an alternative embodiment, application 116 may contain a seating chart for the venue, together with available seats for purchase within the seating chart.

In an exemplary embodiment, VR rendering engine 118 receives generated seat vantage-point data from virtual reality module 130, on server 120, and renders the received data in a virtual reality environment to be displayed on display 112.

With continued reference to FIG. 1, server 120 contains venue database 122 and virtual reality module 130, and may be a laptop computer, tablet computer, netbook computer, personal computer (PC), a desktop computer, a personal digital assistant (PDA), a smart phone, or any programmable electronic device capable of communicating with computing device 110 and database server 140 via network 102. While server 120 is shown as a single device, in other embodiments, server 120 may be comprised of a cluster or plurality of computing devices, working together or working separately. In a preferred embodiment, server 120 may be implemented in a cloud computing environment, as described in relation to FIGS. 6 and 7, herein.

In an exemplary embodiment, venue database 122 is a database storage that contains the seating charts for various venues and locations. For example, venue database 122 may include the seating chart for a hockey game at a particular venue as well as the seating chart for a basketball game at the same venue. Venue database 122, in exemplary embodiments, is capable of being updated dynamically based on information received from application 116, or by a third party.

In an exemplary embodiment, virtual reality module 130 contains instruction sets, executable by a processor, which may be described using a set of functional modules. The functional modules of virtual reality module 130 may include retrieving module 132, receiving module 134, generating module 136, and transmitting module 138.

In an exemplary embodiment, database server 140 includes ticket vendor database 142 and may be a laptop computer, tablet computer, netbook computer, personal computer (PC), a desktop computer, a personal digital assistant (PDA), a smart phone, a server, or any programmable electronic device capable of communicating with computing device 110 and server 120 via network 102. While database server 140 is shown as a single device, in other embodiments, database server 140 may be comprised of a cluster or plurality of computing devices, working together or working separately.

In an exemplary embodiment, ticket vendor database 142 contains seat availability for an event at a particular venue and location. For example, if the seats for rows 1-20 in mezzanine are sold out for Game 1 of the hockey playoffs at Madison Square Garden, then a user will not be able to select these seats for viewing, or purchase, within application 116. In exemplary embodiments, ticket vendor database 142 may be updated dynamically based on seat purchases, returns, holds, and so forth. In an exemplary embodiment, ticket vendor database 142 may be organized according to a venue location (e.g. Washington D.C., New York City, San Francisco), an event category (e.g. ballet, sporting event, concert), venue name (e.g. Metlife Stadium, Beacon Theatre, CitiField) or any other category or organization deemed most useful for the invention to be utilized.

In various embodiments, ticket vendor database 142 may be capable of being stored on server 120 or computing device 110, as a separate database.

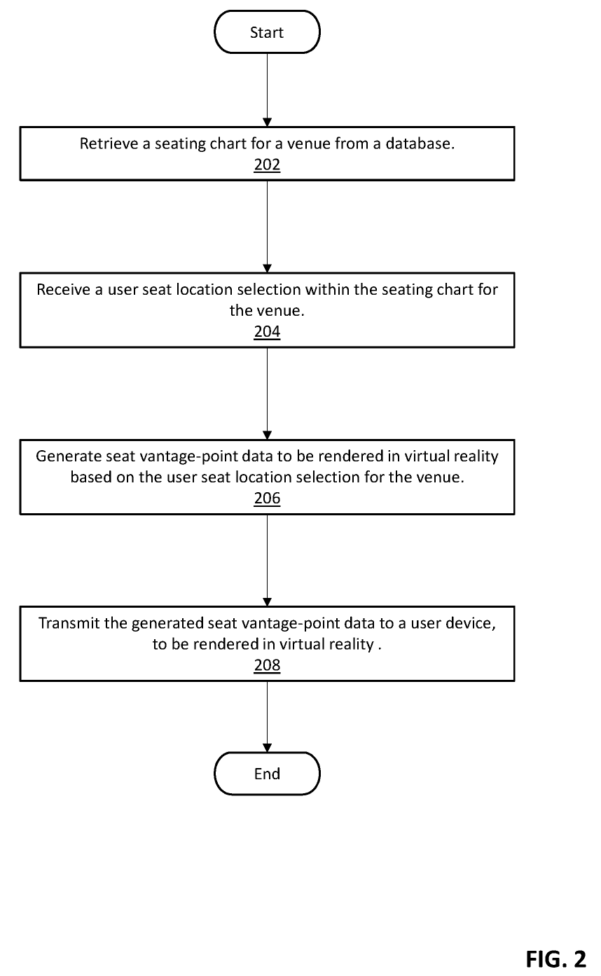

FIG. 2 is a flowchart illustrating the operation of virtual reality module 130, in accordance with an embodiment of the present invention.

Referring now to FIGS. 1 and 2, retrieving module 132 includes a set of programming instructions in virtual reality module 130. The set of programming instructions is executable by a processor. Retrieving module 132 retrieves a seating chart for a venue from a database (step 202). In exemplary embodiments, retrieving module 132 may retrieve a seating chart for a venue from venue database 122, ticket vendor database 142, a database stored locally on computing device 110, or directly from application 116. In alternative embodiments, retrieving module 132 may receive a seating chart from any other third party device or database.

With continued reference to FIGS. 1 and 2, receiving module 134 includes a set of programming instructions in virtual reality module 130. The set of programming instructions is executable by a processor. Receiving module 134 receives a user seat location selection within the seating chart for the venue (step 204).

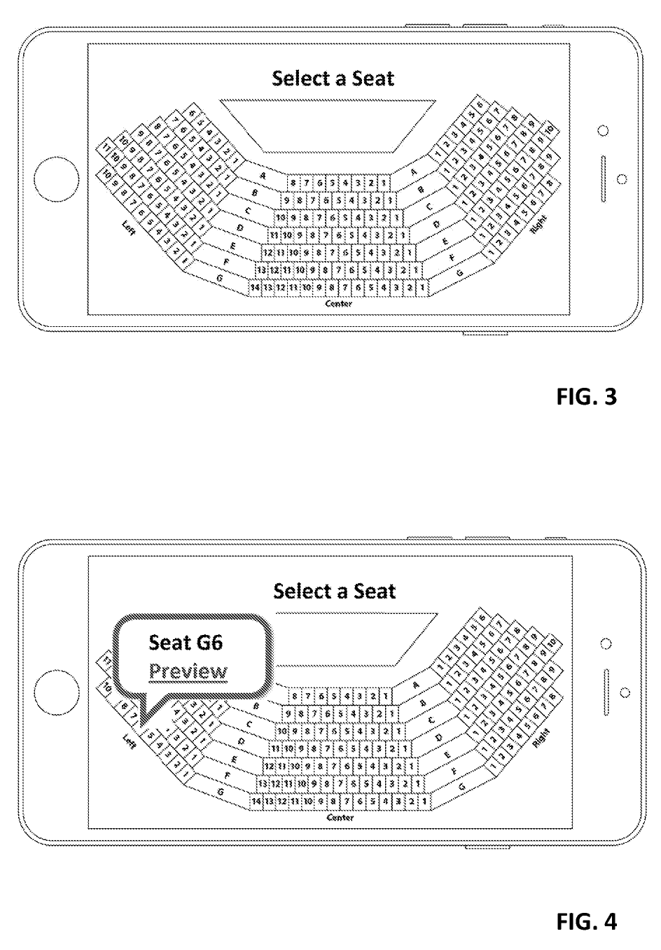

FIG. 3 depicts a seating chart for a venue on a user device, in accordance with an embodiment of the present invention.

FIG. 4 depicts an interactive preview of a user seat location selection within a seating chart for a venue on a user device, in accordance with an embodiment of the present invention.

Referring now to FIGS. 3 and 4, a user may navigate a ticket purchasing website, such as application 116, and view an interactive seating chart (FIG. 3) whereby the user is able to “preview” a seat selection from a seat vantage-point, rendered in virtual reality, by clicking a link (FIG. 4). As depicted in FIG. 4, a user may be able to preview seat G6 at a particular venue prior to purchasing the ticket for that particular seat location.

In a preferred embodiment, application 116 would call an application programming interface (API) for virtual reality module 130 as a service. The selected seat information (i.e. seat number, venue, ID, etc.) is transmitted to virtual reality module 130, via network 102, and a VR-enabled view of the venue, from the vantage point of the selected seat location, would be generated and transmitted to computing device 110.

In a preferred embodiment, the user would hold computing device 110 (e.g. mobile device) horizontally and place the computing device 110 into a VR headset in order to preview the seat selection in virtual reality, in accordance with embodiments of this invention. In alternative embodiments, if the user navigated to a third party vendor website on a laptop or other non-mobile device, the user may simply be presented with a two-dimensional vantage-point perspective from the chosen seat selection.

In an exemplary embodiment, receiving module 134 receives a seat availability, within the seating chart for the venue, for an event. For example, a user may only be able to view available seats within a seating chart for an event, and unable to view already purchased, or reserved, seats. An event, in exemplary embodiments, may include a sporting event, a concert, a play, a show, a ballet, an opera, or any other live or recorded presentation in front of an audience.

In a further embodiment, receiving module 134 may receive a purchase request for a user seat location for the venue and remove the user seat location selection from the seat availability, within the seating chart for the venue, for an event. In this fashion, subsequent users will be unable to view the purchased seat location for a particular event, since the seat location is no longer available for purchase. In alternative embodiments, a user may purchase a seat location selection for an event through application 116, and ticket vendor database 142 may update the seat availability within the seating chart for the venue based on the seat location selection purchase. In alternative embodiments, a user may be capable of viewing all seat locations, within the seating chart for the venue, for an event, whether the seat location is available or not.

With continued reference to FIGS. 1 and 2, generating module 136 includes a set of programming instructions in virtual reality module 130. The set of programming instructions is executable by a processor. Generating module 136 generates seat vantage-point data to be rendered in virtual reality based on the user seat location selection for the venue (step 206).

In exemplary embodiments, generating module 136 may be capable of adjusting the generated seat vantage-point data to be rendered, in virtual reality, based on a received updated user seat location within the seating chart for the venue, for an event. For example, with continued reference to the illustrative example depicted in FIGS. 3 and 4, a user may select seat G6 to preview in VR by clicking on the link from application 116. The user may subsequently change their mind and select a different seat by clicking on the link for G17 instead. Generating module 136 will then adjust the generated seat vantage-point data to be rendered in VR, based on the updated user seat selection.

In alternative embodiments, a user may be capable of interacting with a VR venue based on voice commands of the user. For example, a user may command “show me an available seat closer to center stage.” Generating module 136 may thus be capable of generating seat vantage-point data for one or more available seats within the venue based on the voice commands of the user. In various alternative embodiments, a user may be capable of interacting with the VR environment in any other way that is known to one of ordinary skill in the art, such as wands, gestures, body movements, and so forth.

In exemplary embodiments, generating module 136 may be capable of generating various seat vantage-point data to be rendered in VR such as a user perspective looking towards the stage or central location of an event performance, a user perspective 180 degrees from the seat location selection, and a user perspective 360 degrees from the seat location selection. In alternative embodiments, various other user perspectives in VR, known to one of ordinary skill in the art, may be generated based on a seat vantage-point. The generated VR renderings for a specific seat location at a particular venue may be saved locally on server 120 or saved on database server 140, for future use.

With continued reference to FIGS. 1 and 2, transmitting module 138 includes a set of programming instructions in virtual reality module 130. The set of programming instructions is executable by a processor. Transmitting module 138 transmits the generated seat vantage-point data to a user device, to be rendered in virtual reality (step 208). In exemplary embodiments, transmitting module 138 transmits the generated seat vantage-point data to a user device via network 102.

FIG. 5 is a block diagram depicting components of a computing device in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing device of FIG. 5 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as virtual reality module 130, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 5 may also include a R/W drive or interface 914 to read from and write to one or more portable computer readable storage media 926. Application programs 911 on computing device may be stored on one or more of the portable computer readable storage media 926, read via the respective R/W drive or interface 914 and loaded into the respective computer readable storage media 908.

Computing device of FIG. 5 may also include a network adapter or interface 916, such as a TCP/IP adapter card or wireless communication adapter (such as a 4G wireless communication adapter using OFDMA technology). Application programs 911 on computing device of FIG. 5 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 5 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; analytics services 96, including those described in connection with FIGS. 1-7.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for previewing a seat vantage-point in virtual reality for a venue, the method comprising:
retrieving a seating chart for a venue from a database;
receiving a user seat location selection within the seating chart for the venue;
generating seat vantage-point data to be rendered in virtual reality based on the user seat location selection for the venue;
transmitting the generated seat vantage-point data to a user device, to be rendered in virtual reality; and
displaying one or more seat vantage viewpoints, in virtual reality, based on one or more non-keyboard interactions of the user.

2. The computer-implemented method of claim 1, further comprising:
receiving a seat availability, within the seating chart for the venue, for an event.

3. The computer-implemented method of claim 2, further comprising:
receiving, via one or more voice commands of the user, an updated user seat location selection, within the seating chart for the venue; and
adjusting the generated seat vantage-point data to be rendered in virtual reality based on the received updated user seat location selection.

4. The computer-implemented method of claim 2, further comprising:
receiving a purchase request of the user seat location selection for the venue; and
removing the user seat location selection from the seat availability, within the seating chart for the venue, for an event.

5. The computer-implemented method of claim 1, wherein the generated seat vantage-point data rendered in virtual reality shows a stage at the front of the venue, from the received user seat selection.

6. The computer-implemented method of claim 1, wherein the generated seat vantage-point data rendered in virtual reality shows 180 degrees, from the received user seat selection.

7. The computer-implemented method of claim 1, wherein the generated seat vantage-point data rendered in virtual reality shows 360 degrees, from the received user seat selection.

8. A computer program product, comprising a non-transitory tangible storage device having program code embodied therewith, the program code executable by a processor of a computer to perform a method, the method comprising:
retrieving a seating chart for a venue from a database;
receiving a user seat location selection within the seating chart for the venue;
generating seat vantage-point data to be rendered in virtual reality based on the user seat location selection for the venue;
transmitting the generated seat vantage-point data to a user device, to be rendered in virtual reality; and
displaying one or more seat vantage viewpoints, in virtual reality, based on one or more non-keyboard interactions of the user.

9. The computer program product of claim 8, further comprising:
receiving a seat availability, within the seating chart for the venue, for an event.

10. The computer program product of claim 9, further comprising:
receiving, via one or more voice commands of the user, an updated user seat location selection, within the seating chart for the venue; and
adjusting the generated seat vantage-point data to be rendered in virtual reality based on the received updated user seat location selection.

11. The computer program product of claim 9, further comprising:
receiving a purchase request of the user seat location selection for the venue; and
removing the user seat location selection from the seat availability, within the seating chart for the venue, for an event.

12. The computer program product of claim 8, wherein the generated seat vantage-point data rendered in virtual reality shows a stage at the front of the venue, from the received user seat selection.

13. The computer program product of claim 8, wherein the generated seat vantage-point data rendered in virtual reality shows 180 degrees, from the received user seat selection.

14. The computer program product of claim 8, wherein the generated seat vantage-point data rendered in virtual reality shows 360 degrees, from the received user seat selection.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
retrieving a seating chart for a venue from a database;
receiving a user seat location selection within the seating chart for the venue;
generating seat vantage-point data to be rendered in virtual reality based on the user seat location selection for the venue;
transmitting the generated seat vantage-point data to a user device, to be rendered in virtual reality; and
displaying one or more seat vantage viewpoints, in virtual reality, based on one or more non-keyboard interactions of the user.

16. The computer system of claim 15, further comprising:
receiving a seat availability, within the seating chart for the venue, for an event.

17. The computer system of claim 16, further comprising:
receiving, via one or more voice commands of the user, an updated user seat location selection, within the seating chart for the venue; and
adjusting the generated seat vantage-point data to be rendered in virtual reality based on the received updated user seat location selection.

18. The computer system of claim 16, further comprising:
receiving a purchase request of the user seat location selection for the venue; and
removing the user seat location selection from the seat availability, within the seating chart for the venue, for an event.

19. The computer system of claim 15, wherein the generated seat vantage-point data rendered in virtual reality shows a stage at the front of the venue, from the received user seat selection.

20. The computer system of claim 15, wherein the generated seat vantage-point data rendered in virtual reality shows 360 degrees, from the received user seat selection.
